(19) United States
(12) Patent Application Publication
(10) Pub. No.: US 2010/0050746 A1
(43) Pub. Date: Mar. 4, 2010

(54) DETECTION OF SURFACE POROSITY IN MACHINED CASTINGS

(76) Inventors: Philip Koshy, Hamilton (CA); Ian Menzies, Peterborough (CA)

Correspondence Address: OSTROLENK FABER GERB & SOFFEN, 1180 AVENUE OF THE AMERICAS, NEW YORK, NY, 100368403, US

(21) Appl. No.: 12/204,381

(22) Filed: Sep. 4, 2008

(51) Int. Cl. G01N 15/08

(52) U.S. Cl. 73/38

(57) ABSTRACT

The in-process or post-machining detection of intermediate and macro-level surface porosity in machined castings in a machine tool environment.

### FIELD OF THE INVENTION

The present invention relates generally to a non-contact technology based on the principle of pneumatic gauging for the detection of intermediate and macro-level surface porosity in machined castings. The invention is well suited for in-process as well as post-machining monitoring in a machine tool environment.

### BACKGROUND OF THE INVENTION

The production process involving metal casting of components is inherently prone to porosity defects. The revelation of surface porosity is a common problem encountered when machining castings that contain porosities in the immediate subsurface. This renders quality control very difficult and costly. For example, the scrap rate of castings machined in the automotive industry can in some instances be as high as 80% due to surface porosity issues, which are known to be detrimental to the function and performance of the casting if they occur, for example, on a bearing or sealing surface. Numerous factors such as the grade of the work material, flow conditions during pouring, casting pressure, cooling rates and part geometry affect the nature and extent of porosity in a casting, which renders the casting process difficult to control. The process conditions typically found in a machining environment, such as the presence of debris, dirt, cutting fluid, vibration, lighting conditions and other factors affect the reliability of the technology presently available for in-process surface porosity detection. As such, current attempts to detect surface porosity are more suitable for post-machining inspection.

In the state of the art, metal castings can be inspected non-destructively using X-ray techniques before they are machined. However, depending on the application, the implementation of such techniques can be prohibitively expensive, and in many instances may not even be warranted since porosities, other than those close to the surface, may not pose any problems for the end use. Indeed, depending on their location on the component, surface porosity clusters are permissible provided they do not interfere with the component function.

Castings can be inspected for surface porosities either in-process or post-machining. Depending on the specific application being contemplated, post-machining inspection can have serious cost and quality implications. An example is found in the automotive sector, where a large number of castings are subject to several serial machining operations in transfer lines, which represents significant cumulative value addition. If surface porosity is not detected in-process and in real-time, should a porosity appear on a critical surface earlier on in the process chain, the component is inadvertently still subjected to further value addition, which is eventually lost as the component is ultimately destined to scrap, having not met the post-machining surface porosity specifications.

In contrast, post-machining inspection can be more suitable under certain conditions, for example for small parts where the completion of the tooling demands a relatively small amount of labour. In this case the disadvantage of possible post-inspection scrapping of a certain number of units is compensated by simplification of the inspection process when compared to in-process inspection.

Computer vision and optical imaging technologies can be used for off-line inspection, but these techniques are relatively expensive and tend to be affected by the presence of cutting fluid and machining debris. Furthermore, it takes additional time to inspect a component after the machining process is completed.

A pneumatic gauging tool for assessing surface roughness is disclosed in PCT/CA2007/000315 (PCT Publication No. WO 2007/098587). While surface porosity and surface roughness can be related conceptually, the detection and relevance of each is very different from an engineering perspective. The roughness of a machined surface, such as the feed marks left behind by the machining tool, is considered to be inherent to the surface and, if considered to be within acceptable parameters, is not a surface defect. The measurement of surface roughness involves taking measurements over a given area and calculating an average roughness value which is inherently associated with the surface. In contrast, surface porosity comprises holes, pits and other discontinuities in the surface. Porosity which meets a certain threshold are considered to be defects on the surface. The measurement of surface porosity is therefore performed for comparison to a previously set threshold and the purpose of the measurement is to either qualify or disqualify the casting, not calculate the porosity index itself.

There remains a need for the in-process and post-machining detection of surface porosity in machined castings which do not suffer the drawbacks mentioned above.

### SUMMARY OF THE INVENTION

It is therefore an object of the present invention to provide a method for quantifying surface porosity in machined castings in a reliable, practical and cost-effective manner and which is also amenable to the option of in-process application in a machine shop environment. Preferably the hardware require is robust, relatively inexpensive, capable of being integrated into a cutting tool holder for the in-process application and capable of detecting porosity in workpiece materials.

Furthermore, it is an object of the present invention to materialize the in-process inspection as well as the post-machining inspection of surface porosities. One advantage of the in-process inspection is that it allows assessment of the component during machining with little or no adverse influence on the manufacturing cycle time, as opposed to having to rely on post-machining sampling, thereby reducing the time and resources required to achieve a finished component which has no unacceptable surface porosity, with the consequent improvement of overall product quality. Another object of the present invention is to provide a method for detecting surface porosity that continually cleans the surface being inspected so as to eliminate the potential obscuring influence of machining debris and cutting fluid that could otherwise impede the reliable detection of surface porosity.

Given that not only the number and size of pores is relevant for manufacturing purposes but also the position of the pores, it is also an object of the present invention to provide a method in which the machined surface can be inspected locally and selectively. It is desirable that the present invention allows the inspection of internal surfaces such as that of bore holes.

### BRIEF DESCRIPTION OF THE DRAWINGS

FIG. 1 illustrates a typical example of surface porosity on the machined surface of a cast workpiece according to the present invention;

FIG. 2 illustrates an embodiment of the equipment used in the assessment of surface porosity of a machined casting workpiece with a pneumatic sensor according to the present invention;

FIG. 3(a) illustrates the time evolution of the raw back pressure signal corresponding to a stationary nozzle of one embodiment of the present invention, which is aligned over a simulated surface porosity of diameter 1 mm;

FIG. 3(b) illustrates the evolution of the back pressure illustrated in FIG. 3(a), for the filtered signal;

FIG. 4 illustrates the effect of supply pressure and standoff distance in one embodiment of the present invention;

FIG. 5 illustrates static characteristics of pneumatic sensor in one embodiment of the present invention;

FIG. 6 illustrates the effect of work speed and porosity size in one embodiment of the present invention;

FIG. 7 illustrates an exemplary setup for in-process application according to one embodiment of the present invention;

FIG. 8 illustrates the back pressure signal output indicating a porosity while machining in the presence of a cutting fluid, in one embodiment of the present invention.

### DETAILED DESCRIPTION

The invention will now be described with reference to the figures. The figures are intended to be illustrative rather than limiting and are included herewith to facilitate the explanation of the invention.

This invention relates to a non-contact technology based on the principle of pneumatic gauging for the detection of surface porosity. Its implementation entails the use of a pneumatic sensor for the detection of intermediate and macro-level surface porosity. The sensor performance is characterized in terms of supply pressure, stand-off distance, porosity size and speed of the inspected surface.

The principle of the pneumatic sensor is explained with reference to FIG. 2, which illustrates an embodiment of the equipment used in the assessment of surface porosity of a machined cast workpiece. Air is supplied at constant pressure pₛ through a control orifice to the variable pressure chamber and then on to the atmosphere via a nozzle, so as to impinge upon the work surface that is in its close proximity. Any change in the distance xᵢ between the nozzle and the workpiece due to their relative displacement alters the restriction to the flow of air through the nozzle, which is reflected as a highly sensitive change in the back pressure pₒ in the variable pressure chamber, measured using a sensitive pressure transducer; alternatively, the change in the air flow rate could be measured.

The extension of the principle above to detecting surface porosity is as follows. The presence of a porosity on the surface of the workpiece moving lateral to the nozzle (see FIG. 2) is registered as a rapid change in the back pressure corresponding to the change in the distance xᵢ as the porosity traverses past the nozzle tip. Owing to its simplicity, the system can well be coupled or integrated into a cutting tool holder for in-process application; the hardware is relatively inexpensive, robust and flexible, and the technique is applicable to various sizes and configurations of workpiece materials. Furthermore, selective inspection of surfaces is possible, including internal surfaces such as within bore holes, and the method is readily applied to in-process monitoring in a machine tool environment as the air jet continually cleans the surface being inspected, thereby eliminating the potential obscuring influence of machining debris and cutting fluid. As such, the invention is desirable from the point of view of application in an industrial setting.

For in-process detection of surface porosity, both the response time and the sensitivity of the sensor are of consequence. An increase in both the supply pressure and the ratio of nozzle diameter to orifice diameter would correspond to a higher system sensitivity.

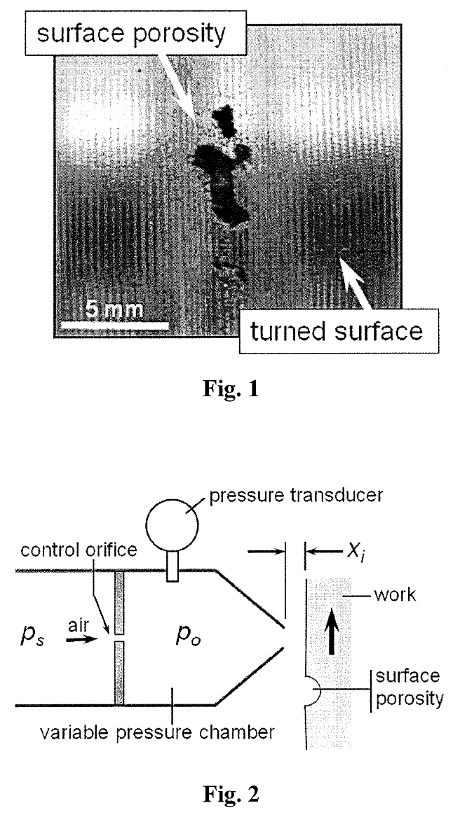

In the casting environment, surface porosities include cavity-type discontinuities or bubbles formed by gas entrapment during solidification of the cast metal workpiece. In contrast, surface roughness corresponds to the inherent, fine, closely-spaced irregularities created by a production process step, for instance machining. One difference between porosity and roughness can be explained with reference to FIG. 1, which depicts a tooled component. The surface porosity cluster, which measures about 2×4 mm² in area, is considered by the skilled worker to be a defect in the machined surface of tooled component. The feed marks left on the surface by the machining tool constitute its roughness. As the feed marks are inherent to the surface, they are not considered a defect. Porosities are typically of a scale larger than roughness.

In a typical industrial application of the present invention, selected, discrete portions of the workpiece are evaluated for porosity against a set standard. Upon checking porosity against a set standard there is no need for storing extensive series of readings, mapping or logging the area for which the readings are acquired. Therefore data acquisition, storage and processing demands less resources than would be the case, for instance, if the purpose were to establish the average roughness of a given workpiece in part or in its entirety.

According to one aspect of the present the invention, a threshold value is defined for surface porosity, duly contemplating the performance requirements of the surface to be machined. An external controlling device is typically employed to store the threshold value. The surface porosity assessment is performed at the time that the workpiece is being machined, and the porosity measurement device reacts to the detection of the previously set threshold value by signaling the event to the external controlling device. The signaling is used as a criterion to discard the workpiece before further processing is inadvertently performed, therefore allowing assessment of each and every workpiece in a series of production with little or no adverse influence on the manufacturing cycle time.

For the in-process embodiment of the present invention, the timing of the porosity assessment (ie: measuring) and machining may be concurrent or almost concurrent, such that the measuring and machining are considered, for quality assurance purposes, to occur at or about the same time.

Moreover, the present invention offers the advantage of selective area inspection, either in process or post-machining, which optimizes the use of resources by limiting the scope of inspection to those areas actually relevant for the workpiece performance. The external controlling device typically stores the information mapping those areas where inspection is necessary. For the in-process inspection option, data collection is interrupted for those areas where inspection is not required, thus reducing overall manufacturing time and costs.

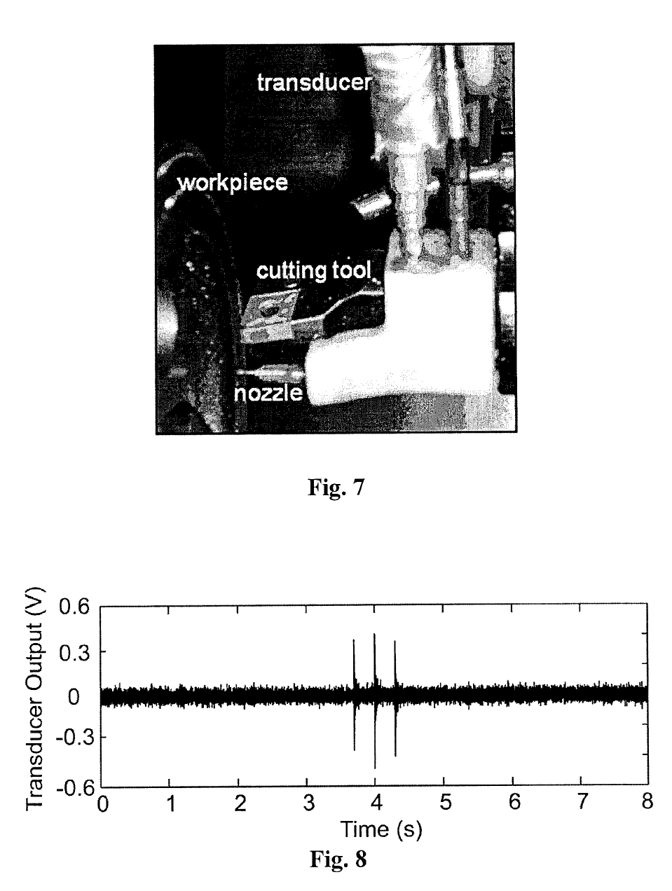

Owing to its simplicity, the porosity measurement device can well be integrated into various cutting tool holders for an in-process application, as shown in FIG. 7. The mounting of the device in the same structural support as the tool holder, with the measurement nozzle geometrically aligned with the cutting tip ensures that the distance between the surface of the working piece and the tip of the measurement nozzle is kept constant regardless of the shape of the workpiece and the corresponding movements of the cutting tool. This way, the movement of the workpiece past the measurement nozzle is dictated by the requirements of the machining operation, with no negative influence over the performance of the porosity assessment. Other mounting options are also contemplated so long as the distance between the porosity measurement device and the work surface can be ascertained.

Another aspect of the present invention is that the geometric pattern of escape of the gas to the atmosphere, associated with the movement of the measurement nozzle in relation to the workpiece actively contributes to the non-destructive removal of debris from small areas of the surface just before these are brought under the measurement nozzle for inspection.

The hardware that constitutes the porosity measurement device is relatively inexpensive, robust and flexible, and the technique is non-contact and applicable to various workpiece materials. Furthermore, the selective inspection of surfaces is possible, including internal surfaces such as bored holes. The method of the present invention is readily amenable to in-process application in a machine shop environment as the gas jet continually cleans the surface being inspected, thereby minimizing or eliminating the presence of machining debris or cutting fluid.

For in-process detection of surface porosity, the pressure transducer must be capable of responding to rapid pressure fluctuations, as the response time has to correspond to the speed at which the component is being machined.

A piezoelectric dynamic pressure transducer was chosen in one embodiment of the present invention as the means to detect fluctuations in back pressure, due to its fast response and high sensitivity characteristics. The pressure transducer used in the experimental analysis featured a sensitivity of 14.5 mV/kPa, a resonant frequency higher than 250 kHz and a rise time of less than 2 μs.

To demonstrate the surface porosity measuring method, an embodiment of the present invention was designed and built. Its effectiveness was characterized in reference to representative porosity sizes and operating conditions. The embodiment's nozzle tip diameter dₙ and the control orifice diameter dₛ of the pneumatic sensor were 0.76 mm and 0.5 mm, respectively. Experiments were conducted in a turning center using a cylindrical workpiece, with its face machined in-place constituting the baseline surface to be inspected. Hemispherical cavities were machined on this test surface to simulate surface porosity. The sensor nozzle was positioned in one of the rotary turret stations such that it was normal to the inspected surface and the stand-off distance xᵢ (nominal distance between the nozzle tip and the inspected surface) could be controlled accurately.

Several experiments were conducted with the embodiment in order to verify which variables are relevant for the surface porosity detection performance. These experiments assessed the effect of supply pressure, stand-off distance, porosity size and workpiece surface speed in the ranges of 70-280 kPa, 50-150 μm, 0.6-1.6 mm and 50-200 m/min, respectively. Experiments were also conducted to assess the capability of the technique while machining in the presence of a cutting fluid, with the sensor coupled or integrated into the cutting tool holder.

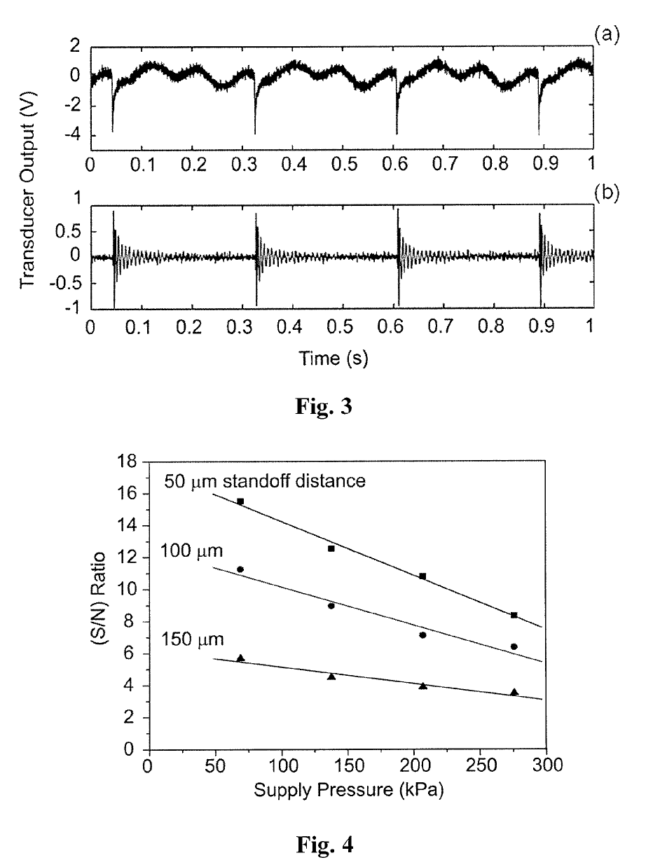

FIG. 3(a) shows the time evolution of the raw back-pressure signal corresponding to a stationary nozzle aligned over a simulated surface porosity of diameter 1 mm. The position of the nozzle corresponded to a stand-off distance of 100 μm. The signal relates to four representative workpiece rotations with the inspected surface traversing at a linear speed of 100 m/min and the supply pressure maintained constant at 200 kPa. The inspected surface featured a maximum static face run-out of 20 μm, and a roughness of 6.3 μm Ra. The effect of workpiece run-out is therefore convolved with the feature representing the presence of the surface porosity in the back pressure signal, in addition to possible workpiece vibration and surface roughness effects. The pressure signal was therefore processed using an infinite impulse response third order elliptic filter to isolate extraneous effects and facilitate the identification of the surface porosity.

FIG. 3(b) shows the filtered signal wherein the spike relating to the porosity can be recognized with no ambiguity. In industrial application conditions, such filtering techniques may not be required if the workpiece run-out is negligible in comparison to the size of the allowable porosity, which varies according to the standards required for each particular workpiece.

Nozzle shape and area also influence the detection performance. In a cylindrical turning operation, as the nozzle traces a helical path along the work surface, the number of peaks registered by a pore depends on its size measured along the workpiece axis in relation to the nozzle diameter. For practical in-process implementation, the nozzle tip diameter ideally should at least match the feed per revolution of the tool, so as to ensure that the entire machined surface gets inspected. In contrast to a circular nozzle that would be preferred for a turning operation, a nozzle of a rectangular shape may be used for inspecting planar surfaces, such as those generated in face milling for instance. If the inspected area is large, multiple sensors with individual pressure transducers may be employed to maximize the sensitivity and robustness of the system. The concept can further be extended to inspect surfaces with complex geometry such as V-groove pulleys by using nozzles of a geometric shape that corresponds to that of the inspected surface.

Further tests were carried out to establish the method's effectiveness with respect to the operating variables. The performance of the system was characterized in terms of the signal-to-noise (S/N) ratio of the filtered signal, defined as the ratio of the minimum peak-to-peak amplitude of the feature corresponding to the surface porosity to the maximum peak-to-peak amplitude of the inherent noise, considering several representative samples. The effect of the supply pressure, stand-off distance, porosity size and the workpiece surface speed were studied, in consideration of their typical operating ranges.

FIG. 4 shows the effect of the supply pressure on the S/N ratio at various stand-off distances, for a 1 mm porosity and 150 m/min workpiece linear speed. The S/N ratio can be seen to increase with a decrease in both the supply pressure and the stand-off distance; it is however more sensitive to the latter. For the range of pressure and stand-off distance investigated, the S/N ratio ranges from about 5 to 15, which attests to the capability of this technique for surface porosity detection. For such high values, detection of surface porosity is rather straightforward as its presence would correspond to a peak that lies well outside of appropriate bounds set in reference to the noise level.

The rate of change of S/N ratio with supply pressure decreases with an increase in the stand-off distance (FIG. 4). As such, the increase in noise level is a consequence of dynamic interactions between the air jet and the surface. It is possible to reduce this noise by such measures as optimizing the nozzle geometry, however this may be only warranted if the S/N ratio is rather low.

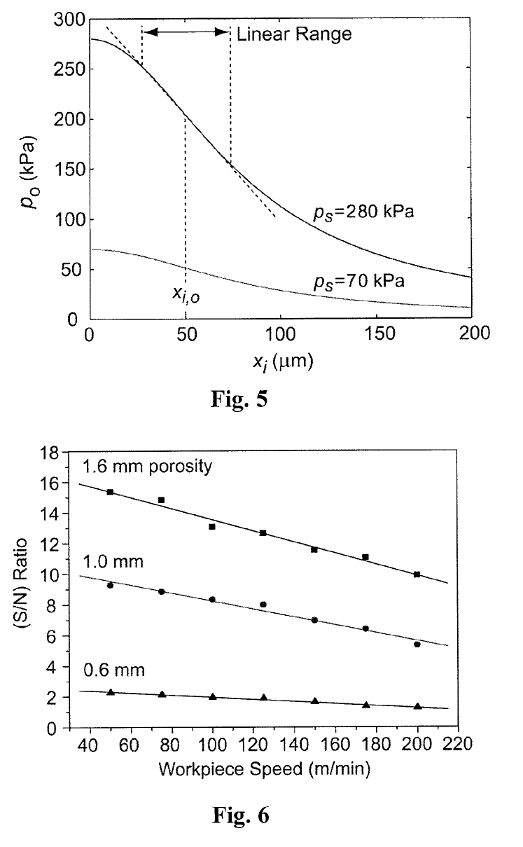

The slope of the static characteristic of the pneumatic sensor (FIG. 5), which refers to its sensitivity, exhibits a maximum with respect to the stand-off distance. For the sensor used in one embodiment, this value corresponds to about 50 μm. For in-process applications, additional factors such as workpiece run-out and vibration, and the effect of tool wear progression are considered with a view to avoiding possible physical contact between the nozzle tip and the inspected surface. The reduction in the standoff distance due to tool wear can be particularly significant in this regard.

For example, for a cutting tool with a clearance angle of 7°, the stand-off distance is reduced by about 37 μm as the tool incurs a flank wear of 300 μm. Similarly, although lower supply pressures correspond to higher S/N ratios (FIG. 4), the operating point is to be determined by considering the pressure required for the jet to effectively clear any machining debris and cutting fluid off the inspected surface. This is a notable advantage of the pneumatic sensor embodiment over optical equivalents.

One difference between the porosity detection method according to the present invention and conventional pneumatic gauging is the relatively high speed of the surfaces under inspection. The motion of the inspected surface and its roughness have been shown to only have a minimal influence on the performance of pneumatic gauges. This implies that, under conditions in which the stand-off distance is otherwise essentially constant, a perturbation in the pressure signal can be attributed to the presence of the porosity. For in-process porosity detection, the effect of surface speed of the inspected surface is important as it directly relates to the cutting speed or feed of the machining operation.

The pneumatic sensor is a first-order instrument, with a typical time constant on the order of several milliseconds. The dynamic performance of the system is impacted by the response time of the piezoelectric pressure transducer used to capture the pressure fluctuation corresponding to the porosity, generally as two orders of magnitude smaller.

The S/N ratio obtained for a representative range of porosity size and work speed is shown in FIG. 6 for a stand-off distance of 100 μm and a supply pressure of 200 kPa. The ratio can be seen to increase with an increase in the porosity size, while exhibiting a modest decrease with an increase in the work speed, as expected for a first-order instrument. For porosity 1 mm in size and above, the data indicates that the S/N factor is high enough for the embodiment's technique to be effective, without having to invoke sophisticated signal processing techniques.

It is also evident that the technique is appropriate for sizing the detected porosity. For smaller porosity and higher work speeds, the S/N ratio approaches 1 and under such circumstances, it might be required to apply such techniques as wavelets to detect singularities in the back pressure signal that correspond to a porosity. It is also possible to improve the dynamic response of the pneumatic sensor embodiment by reducing the effective volume of the variable pressure chamber.

As previously indicated, one of the advantages of a pneumatic sensor embodiment in the detection of surface porosity is the in-process application in a manufacturing environment, wherein optical techniques are not robust. Tests were conducted with the sensor integrated into a cutting tool engaged in machining a grey cast iron workpiece with a porosity of size 1 mm, with a cutting fluid applied in the form of a flood. FIG. 7 illustrates the test set up of this embodiment. The machining process featured a constant surface speed (100 m/min) facing operation at a feed of 0.4 mm/rev and a depth of cut of 0.4 mm. The cutting action was found to introduce significant high frequency noise in the back-pressure signal, which was filtered out using a band pass filter. At a supply pressure of 200 kPa and a stand-off distance of 100 μm, the cutting fluid and the machining debris were effectively removed off the inspected surface, and the pneumatic sensor was able to reveal, as shown in FIG. 8, the porosity with a S/N ratio close to 5, thus validating its capability for in-process application.

The foregoing has constituted a description of specific embodiments showing how the invention may be applied and put into use. These embodiments are only exemplary. The invention in its broadest, and more specific aspects, is further described and defined in the claims which now follow.

We claim:

1. A method of assessing the surface porosity of a workpiece with a porosity measurement device comprising a measurement nozzle from which gas escapes to the atmosphere and a pressure transducer which measures a back pressure signal after said gas contacts a given area of said workpiece, said method comprising the steps of:
a) subjecting said area to machining with a tool having a cutting tip, wherein said tool is mounted on a holder;
b) measuring said back pressure signal with said porosity measurement device; and
c) detecting said surface porosity of said area.

2. A method of evaluating the machining of a workpiece requiring less than an acceptable degree of surface porosity, with a porosity measurement device, wherein said device comprises a measurement nozzle from which gas escapes to the atmosphere and a pressure transducer which measures a back pressure signal after said gas contacts a given area of said workpiece, said method comprising the steps of:
a) subjecting said area to machining;
b) measuring said back pressure signal with said porosity measurement device;
c) calculating a measured degree of surface porosity corresponding to said area;
d) signaling said difference between said measured degree of surface porosity and said acceptable degree of surface porosity.

3. The method of claim 2 further comprising the step of discarding said workpiece if said measured degree of surface porosity exceeds said acceptable degree of surface porosity.

4. The method of claim 2 further comprising the step of continuing to machine said workpiece if said measured degree of surface porosity is within said acceptable degree of surface porosity.

5. The method of claim 1, wherein the steps of machining and measuring are performed concurrently.

6. The method of claim 1 wherein said porosity measurement device is coupled to said holder.

7. The method of claim 6 wherein said measurement nozzle is geometrically aligned with said cutting tip such that the distance between said area and an end of said measurement nozzle nearest said area is kept constant during said machining step.

8. The method of claim 2, wherein the steps of machining and measuring are performed concurrently.
